(19) United States
(12) Patent Application Publication
(10) Pub. No.: US 2014/0120440 A1
(43) Pub. Date: May 1, 2014

(54) COOLANT FLOW PULSING IN A FUEL CELL SYSTEM

(71) Applicant: GM GLOBAL TECHNOLOGY OPERATIONS LLC, Detroit, MI (US)

(72) Inventors: John P. Nolan, Rochester, NY (US); Steven R. Falta, Honeoye Falls, NY (US); Derek R. Lebzelter, Fairport, NY (US); Seth E. Lerner, Honeoye Falls, NY (US)

(73) Assignee: GM GLOBAL TECHNOLOGY OPERATIONS LLC, Detroit, MI (US)

(21) Appl. No.: 13/660,089

(22) Filed: Oct. 25, 2012

(51) Int. Cl. H01M 8/04

(52) U.S. Cl. 429/431; 429/430

(57) ABSTRACT

Systems and methods to control the delivery of coolant to a coolant loop within a vehicular fuel cell system. During periods of low power output from one or more fuel cell stacks, operation of a pump used to circulate coolant through the loop is intermittent, thereby reducing pump usage during such times. The frequency of pump operation, as measured by a pump on/off (i.e., pulsed) cycle, may be adjusted to keep a local temperature rise within the one or more stacks to no more than a small amount over the bulk stack temperature.

### BACKGROUND OF THE INVENTION

The present invention relates generally to controlling a pump in a fuel cell system, and more particularly to systems and methods for pulsing the flow of coolant to a fuel cell stack in order to reduce parasitic power consumption while limiting stack temperature differential at low stack power levels.

Fuel cells—as an alternative to using gasoline or related petroleum-based sources as the primary source of energy in vehicular propulsion systems —operate by electrochemically combining reactants. In a representative fuel cell, one of the reactants is typically hydrogen-based and supplied to the anode of the fuel cell, where it is catalytically broken down into electrons and positively charged ions. A proton-conductive electrolyte membrane separates the anode from the cathode and allows the ions to pass to the cathode. The generated electrons form an electric current that is routed around the electrolyte layer through an electrically-conductive circuit that includes a motor or related load such that useful work is produced. The ions, electrons, and supplied oxygen (often in the form of ambient air) are combined at the cathode to produce water and heat. In one automotive form, the motor being powered by the electric current may propel the vehicle, either alone or in conjunction with a petroleum-based combustion engine. Individual fuel cells may be arranged in series or parallel as a fuel cell stack in order to produce a higher voltage or current yield. Furthermore, still higher yields may be achieved by combining more than one stack.

The heat generated by the reactions in the fuel cell system must be regulated in order to provide efficient system operation, as well as keep the temperature of the system components within their design limits. To accomplish the regulation of heat, coolant flow fields are set up adjacent the reactant flow fields such that a coolant being pumped through the coolant flow fields conveys away excess heat present in the reaction. From there, the coolant is routed to a radiator or other appropriate heat sink to allow the heat to be dissipated.

It is more challenging to control the speed of the pump used to circulate the coolant during a low power state. For example, continuous pump operation in a low-load stack condition necessitates significant consumption of the electric current produced by the fuel cell, thereby significantly impacting overall system efficiency. The limited ability of the coolant pump to turn down relative to the fuel cell system (where, for example, the fuel cell system will turn down more than 100 to 1 while the pump will only turn down 5 to 1) further hampers the ability of the coolant system to control temperature differences through the stack at such low power levels. In the present context, the ability of equipment to turn down (also referred to herein as “turndown ratio”), is a measure of the pump's maximum coolant flowrate relative to its minimum coolant flowrate. Similarly, the fuel cell system's turndown can be defined as its rated maximum power relative to its minimum power. Since the fuel cell stack's waste heat has a slightly superlinear scale with system power, the fact that the system can turn down beyond the coolant pump means that the coolant pump provides much more coolant flow than is needed to adequately cool the stack and maintain reasonable coolant temperature differences from the inlet and outlet of the stack. Unfortunately, such excess pump capacity leads to operational inefficiencies of the fuel cell system.

### SUMMARY OF THE INVENTION

In a first embodiment of the invention, a method of controlling a coolant pump in a fuel cell system is disclosed. In one particular form, the present invention allows effective turn down ratios greater than 5 to 1 to be better responsive to the turn down ratio of the stack or other part of the fuel cell system. While the method is particularly well-suited for use in vehicular applications, it will be appreciated by those skilled in the art that non-vehicular fuel cell applications employing the present invention are also within the scope of the present invention. The method includes determining whether a stack power request for a fuel cell stack is below a first threshold value. As such, the method is particularly configured for low power operational conditions. The method also includes utilizing the stack power request—when it is below the first threshold value —to determine an off time value for a coolant pump that provides coolant to the fuel stack. The method further includes generating, by a processor, a coolant pump control command that causes the coolant pump to selectively provide coolant to the fuel stack such that during the off time, the pump ceases to provide coolant to the fuel stack, while during an on time, the pump is operated to provide coolant. In this way, the delivery of the coolant takes place in a pulsed fashion. Of special significance is that the pump pulsing of the present invention is based on a determination of a pulsing frequency that limits the localized temperature rise of any part within the fuel cell stack to a small amount above the average system temperature within the fuel cell stack. In one form, the maximum permissible local temperature rise is a few degrees, for example, about 3° C. Significantly, during pulsed pump operation, there is a minimum time that the coolant pump must run while in an “on” condition in order to remove the heat produced by the fuel cell stack during the periods where the pump was off. In one form, a typical time is between about 3 and 10 seconds, and is dependent on the thermal mass of the stack and the flowfield design. Likewise, the maximum permissible local temperature rise mentioned above may vary depending on other factors (such as humidification). As such (and depending on variations in such factors), there may be a wider range of acceptable temperatures, for example from 1° C. to 7° C.

In another embodiment, a controller for a fuel cell system is disclosed. The controller includes one or more processors and a non-transitory memory in communication with the one or more processors. The memory stores instructions that, when executed by the one or more processors, cause the one or more processors to determine whether a stack power request for a fuel cell stack is below a first threshold value. The instructions further cause the one or more processors to utilize the stack power request to determine an off time value for a coolant pump that provides coolant to the fuel stack. The instructions additionally cause the one or more processors to generate a coolant pump control command that causes the coolant pump to stop providing coolant to the fuel stack during the off time and to provide coolant to the fuel stack during an on time, if the stack power request is below the first threshold value.

In yet another embodiment, a fuel cell system is disclosed that includes a fuel cell stack, a pump for delivery of a coolant through the fuel cell stack and a pump controller comprising one or more processors and a non-transitory memory in communication with the one or more processors. The memory stores instructions that, when executed by the one or more processors, cause the one or more processors to determine whether a stack power request for a fuel cell stack is below a first threshold value. The instructions also cause the one or more processors to utilize the stack power request to determine an off time value for a coolant pump that provides coolant to the fuel stack. The instructions further cause the one or more processors to generate a coolant pump control command that causes the coolant pump to stop providing coolant to the fuel stack during the off time and to provide coolant to the fuel stack during an on time, if the stack power request is below the first threshold value.

### BRIEF DESCRIPTION OF THE DRAWINGS

The following detailed description of specific embodiments can be best understood when read in conjunction with the following drawings, where like structure is indicated with like reference numerals and in which:

FIG. 1 is an illustration of a vehicle having a fuel cell system;

FIG. 2 is a schematic illustration of the fuel cell system shown in FIG. 1;

FIG. 3 shows a the pulsation and pulsating frequency of a coolant pump used in the fuel cell system of FIG. 2; and

FIG. 4 is a flow chart showing the decisions made in order to determine pulsing operation for the coolant pump of FIG. 2.

The embodiments set forth in the drawings are illustrative in nature and are not intended to be limiting of the embodiments defined by the claims. Moreover, individual aspects of the drawings and the embodiments will be more fully apparent and understood in view of the detailed description that follows.

### DETAILED DESCRIPTION OF THE PREFERRED EMBODIMENTS

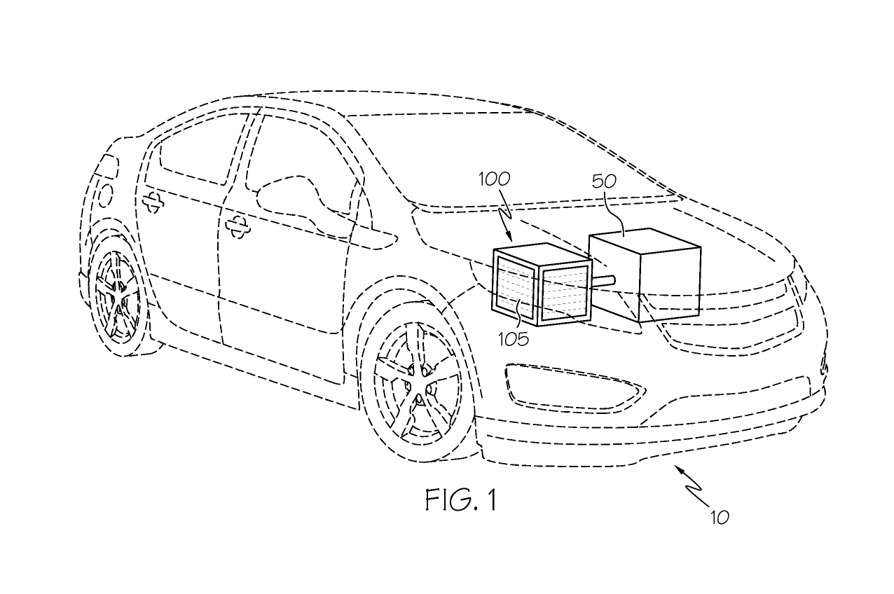

Referring first to FIG. 1, vehicle 10 is shown, according to embodiments shown and described herein. It will be appreciated by those skilled in the art that while vehicle 10 is presently shown configured as a car, it may also include bus, truck, motorcycle or related configurations. Vehicle 10 includes engine 50, which may be a fully electric or a hybrid electric engine (e.g., an engine that uses both electricity and petroleum-based combustion for propulsion purposes). A fuel cell system 100 that includes at least one stack 105 of individual fuel cells may be used to provide at least a portion of the electric power needs of engine 50. In a preferred form, the fuel cell system 100 is a hydrogen-based one that may include one or more hydrogen storage tanks (not shown), as well as any number of valves, compressors, tubing, temperature regulators, electrical storage devices (e.g., batteries, ultra-capacitors or the like), and controllers that provide control over its operation.

Any number of different types of fuel cells may be used to make up the stack 105 of the fuel cell system 100; these cells may be of the metal hydride, alkaline, electrogalvanic, or other variants. In one preferred (although not necessary) form, the fuel cells are polymer electrolyte membrane (also called proton exchange membrane, in either event, PEM) fuel cells. Stack 105 includes multiple such fuel cells 105A-N combined in series and/or parallel in order to produce a higher voltage and/or current yield. The produced electrical power may then be supplied directly to engine 50 or stored within an electrical storage device for later use by vehicle 10.

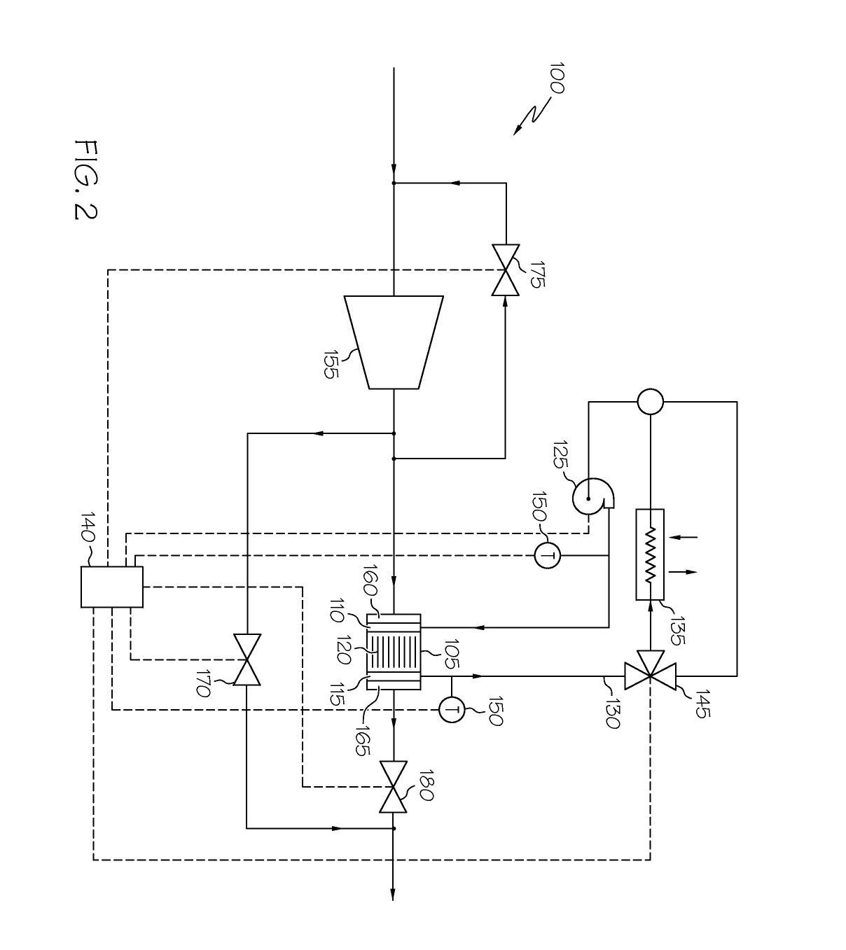

Referring now to FIG. 2, a schematic illustration of fuel cell system 100 is shown, according to embodiments shown and described herein. The fuel cell system 100 includes a fuel cell stack 105 that includes an inlet cooling fluid manifold 110 and an outlet cooling fluid manifold 115 fluidly coupled to one another by cooling fluid flow channels 120. Coolant pump 125 circulates a cooling fluid through a substantially closed-circuit coolant loop 130, where a radiator 135 removes heat from the cooling fluid by exchanging it with a suitable heat sink (indicated by the arrows). Controller 140 regulates the speed of the pump 125, as well as the opening and closing of one or more valves 145 so that during normal operation of fuel cell stack 105, it is maintained at a desirable operating temperature (for example, approximately 80° C.). One or more temperature sensors 150 may be used to measure the temperature of the cooling fluid in various locations within the coolant loop 130. The measured signals may be sent to the controller 140 for subsequent processing or decision-making. The coolant loop 130 uses valve 145 (presently shown as a three-way valve) to include a parallel loop with the radiator 135 such that valve 145 controls what goes into the radiator 135 and what bypasses while never preventing coolant flow into the stack 105. Significantly, because coolant pump 125 is a variable speed pump, there is no need for a separate valve to control the coolant flowrate.

Other parts of the fuel cell system 100 include a cathode compressor 155 that is configured to pressurize reactant air and deliver it to the cathode side 160 of stack 105, while the reactant fuel (such as hydrogen) is delivered to the anode side 165 of stack 105. Exhaust gases and/or liquids are then removed from stack 105 to be discharged. A number of other valves, such as bypass valve 170, recirculation valve 175 and backpressure valve 180, may be included for other system features. For example, bypass valve 170 may be used to dilute the hydrogen left in the cathode of stack 105 that is introduced for catalytic heating. In this way, it is possible to reduce the hydrogen concentration (such as during stack warm-up), as well as for voltage suppression to let compressor 155 sink the stack load. More particularly, the bypass valve 170 can achieve this dilution of the excess hydrogen coming out of the stack 105 by introducing fresh air to the outlet of the cathode side 160 of the stack 105. As mentioned above, one scenario where such excess hydrogen may be present is that associated with post-shutdown from a previous operation, where the hydrogen that crossed over the various fuel cell membranes remains in the stack until the subsequent start (where the fuel cell system 100 will then open the bypass valve 170 to permit the hydrogen diffusion). The bypass valve 170 may also be used with catalytic heating in case the stack 105 does not convert all the hydrogen to water and the outlet stream needs fresh air to dilute the hydrogen. Likewise, bypass valve 170 may be used by the fuel cell system 100 to bypass air in situations where too much air may otherwise go through the stack 105 that could cause excessive drying out of the fuel cell membranes. For simplicity, FIG. 2 shows only a cathode and coolant loop, although it will be appreciated by those skilled in the art that a comparable anode loop may also be present that may be configured to operate, mutatis mutandis, in a generally comparable manner.

Unlike a system where pulsing of coolant pump 125 may be employed to clear gas bubbles in a reactant or coolant flowpath (such as coolant loop 130) as a way to prevent localized hot spots, the present invention (in its emphasis on coolant loop rather than reactant loop operation) doesn't concern itself with the presence of gas bubbles, instead focusing on a control strategy that—through an intentional reduction in coolant flow—produces localized hot spots. More particularly, the control discussed in detail herein determines the coolant pump 125 pulsing frequency f such that intentional localized temperature rises of no greater than a predetermined maximum value are produced. In one even more particular form (and for a given system power level), the localized hot spot temperature rise is kept to within about 3° C. above the average system (i.e., stack 105) temperature through a suitable coolant pump 125 pulsing frequency f. In the present context, a local or localized hot spot is one that is of a discrete (rather than systemic) nature. Thus, rather than being indicia of a significant portion (or the substantial entirety) of the fuel cell stack 105 temperature level, a local hot spot would at most cover individual-sized positions in the stack 105 such that a temperature-measuring or related heat-sensing component (if present, such as temperature sensor 150) could discern the difference.

To the extent that cooling flow pulsing may have been employed in the known art, it is done so with nominal pump operation as a way to produce a concomitant nominal flow of the coolant. Such an approach involves attempting to pulse the flow between two non-zero flow rates (for example, operating at conditions x+y and x−y around a nominal set point x) as a way to create unsteady flow conditions in the respective flowpaths. By contrast, the present invention includes pulsing between the nominal set point and the minimum flow that the pump 125 can provide, which for very low system power levels is zero, thereby minimizing the parasitic power draw of the pump 125.

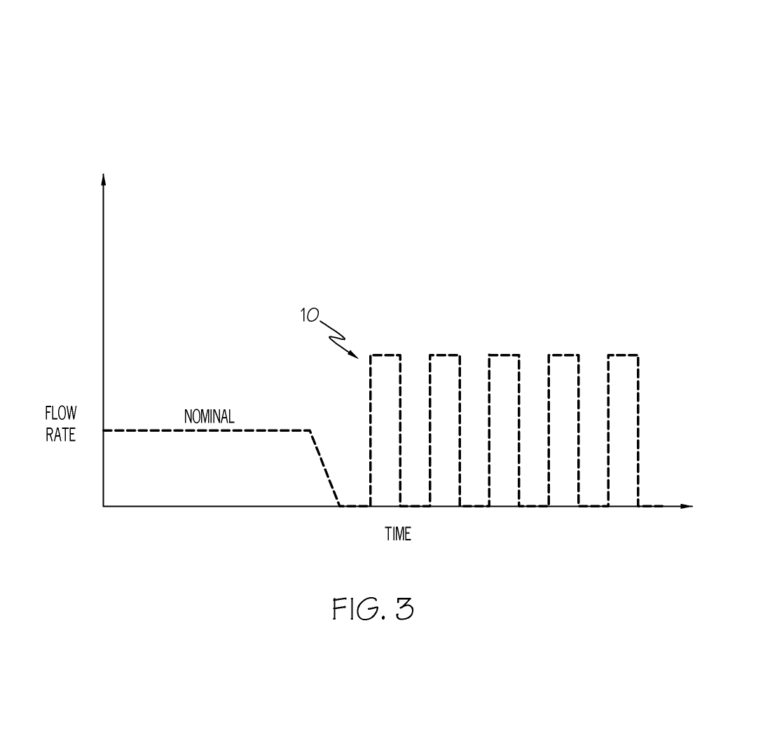

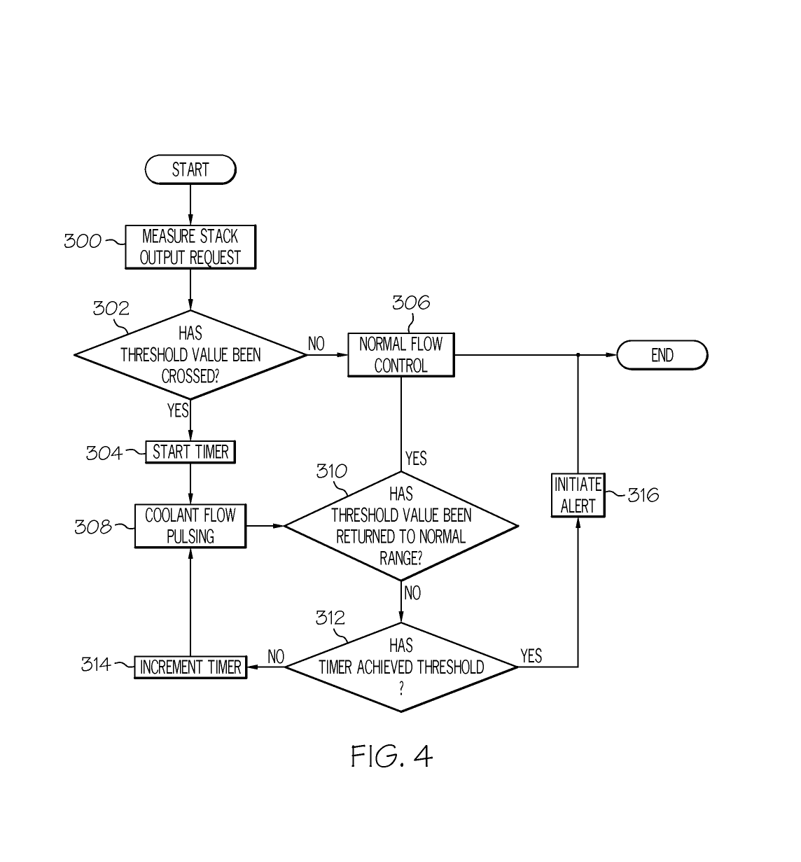

Referring next to FIGS. 3 and 4 in conjunction with FIG. 2, in one form of operation where the power requirements of stack 105 are relatively low (such as during vehicle idle), the need for coolant flow through coolant loop 130 is reduced. In this circumstance, and in a manner unlike that of a conventional approach, the controller 140 can send signals to the pump 125 to have it deliver a pulsed flow of coolant through loop 130. In operational modes where flow pulsing (rather than continuous flow) is taking place, it is preferable to hold the valve 145 in the same position as it was at the start of the pulsing and keep it constant until the flow pulsing stops, as trying to control the valve during flow pulsing conditions would otherwise add another layer of complexity. In a preferred form, the controller 140 controls an on/off cycle of pump 125 so that periodic bursts of cooling fluid are injected into the inlet manifold 110. Moreover a pulsed signal sent from controller 140 to pump 125 instructs it on how frequently to turn the pump 125 on and off; this frequency f is at a rate necessary to provide this intermittent cooling fluid flow such that a local temperature rise within stack 105 remains below a threshold difference over that of the remainder (or average) of the stack 105. Many variables may be used to determine the frequency f (also known as duty cycle) of the on/off (i.e., pulsed) operation, based on operating parameters such as the load on the stack 105, the volume and temperature of the cooling fluid in coolant loop 130, the ambient temperature, passenger compartment heating requests, hydrogen bleeding from the anode to the exhaust, or the like. Further, the pump 125 may be left on for a minimum amount of time in order to retrieve original coolant temperatures, as well as remove bubbles from the flowfield. Thus, for example, increasing temperatures of the cooling fluid, as well the amount of coolant being passed through the coolant loop 130 may cause the duty cycle or frequency of the pulsed signal to be increased until the pump 125 is in continuous operation.

In one form, the time the pump spends in the “off” (i.e., non-operating) condition may be about 3 to 10 seconds, and more particularly, about 5 seconds, while the stack power request that is used to determine the threshold may be about 0.1 amperes per square centimeter. In another form, the time the pump spends in the “off” condition may be about 10 to 30 seconds, and more particularly about 15 seconds if the stack power request is below about 0.05 amperes per square centimeter, while the off the “off” condition time may be about 30 to 80 seconds, and more particularly about 50 seconds if the stack power request is about 0.02 amperes per square centimeter and about 50 to 200 seconds, and more particularly about 100 seconds if the stack power request is about 0.01 amperes per square centimeter. Moreover, even longer “off” times may be permissible at lower current densities because of the lower rate of heat accumulation in the system; it will be appreciated by those skilled in the art from the preceding that the pump duty cycle is subject to system size and configuration, and that these and other particular values are within the scope of the present invention. Likewise, it is preferable to have pump 125 “on” time correspond to a minimum run time to ensure removal of the heat that is still being produced by stack 105 during pump “off” time. In one form, a typical time may be between about 3 and 10 seconds, although such values are dependent on the thermal mass of the stack 105 and the flowfield design.

In a more detailed form, operating parameters taken into consideration by the algorithm include stack 105 electrical load, cabin heating request, anode bleed and coolant temperature. Other factors, such as non-pulse pump speed requests, may be determined by a different algorithm. When one or more of these parameters crosses a predetermined threshold, the controller 140 generates a signal that can be used to cycle the pump 125 on and off as a way to achieve the necessary coolant flow through loop 130 without pumping too much. It is important to recognize that controlling one device (such as pump 125) often impacts other parts of fuel cell system 100. As such, a formula, algorithm or related strategy used by controller 140 may take advantage of feedback or feedforward terms that take component setpoints, as well as the operational parameters discussed above, into consideration.

Controller 140 includes one or more processors (e.g., a microprocessor, an application specific integrated circuit (ASIC), field programmable gate array or the like) communicatively coupled to memory and interfaces (such as input/output interfaces). These interfaces may receive measurement data, as well as transmit control commands to the various valves (such as valve 145), pump 125 and other devices. The interfaces may also include circuitry configured to digitally sample or filter received measurement data, such as temperature data received from temperature sensor 150; this data may be configured to be delivered continuously or intermittently at discrete times (e.g., k, k+1, k+2, etc.) to produce discrete temperature values (e.g., T(k), T(k+1), T(k+2), etc.). The memory may be any form capable of storing machine-executable instructions that implement one or more of the functions disclosed herein, when executed by the processor. For example, the memory may be RAM, ROM, flash memory, hard drive, EEPROM, CD-ROM, DVD or other forms of non-transitory devices, as well as any combination of different memory devices.

Furthermore interfaces and related connections between controller 140 and the various components of fuel cell system 100 may be any combination of hardwired or wireless variety. In some embodiments, the connections may be part of a shared data line that conveys measurement data to controller 140 and control commands to the devices, while in other embodiments, the connections may include one or more intermediary circuits (such as other microcontrollers, signal filters or the like) and provide an indirect connection between the controller 140 and the various system components. In one form, the use of one or more arithmatic unit processors, input, output, memory and control gives controller 140 attributes that allow it to function as a von Neumann computer.

The memory of controller 140 may be configured to store a program or related algorithm that uses measurement data, operational conditions or related parameters, as well as charts, formulae or lookup tables as a way to provide control over various components, such as pump 125. The controller 140 may include proportional-integral (PI) or proportional-integral-digital (PID) attributes that utilizes a feedback loop based on operational parameters, such as reactant flow needed by fuel cell stack 105. Furthermore, controller 140 may utilize a feedforward-based control loop. In either case, controller 140 may generate an algorithmically-based control command that causes the pump 125 to change its operating state, such as its speed or pulsing frequency. It can likewise provide data to control opening and closing of valve 145 (as well as other valves). In one form, the lookup table, formulae or charts may include information derived from a pump or compressor map, as well as information derived from pressure drop models that in turn may utilize setpoint and/or feedback data from the controller 140. In some embodiments, some or all of the operational parameters may be pre-loaded into memory (such as by the manufacturer of the controller 140, vehicle 1 or the like). In other cases, some or all of parameters may be provided to controller 140 via the interface devices or other computing systems. Further, some or all of parameters may be updated or deleted via the interface devices or other computing systems.

Referring with particularity to FIG. 4 in conjunction with FIG. 2, the algorithm embedded in controller 140 includes various decision points that are used to determine whether the coolant pump 125 should be pulsed, and if so, to what pulsing frequency f. Initially, at step 300, the controller 140 looks at the measured load on the stack 105 as determined by a current sensor (not shown). In step 302, the controller 140 compares the measured load from step 300 to a threshold value, where such threshold may be stored in a lookup table or other memory device. The controller 140 also checks additional criteria. For example, it verifies or checks on issues related to cabin heating requests, anode bleed and coolant temperature (this last one, for example, pertaining to whether the temperature is below an upper limit). If any of these conditions aren't true, then normal flow control continues, as shown in step 306. If on the other hand the conditions for flow pulsing are met, the timer starts at step 304 and the coolant flow pulsing begins at step 308. In one preferred form, the algorithm uses the measured load on the stack 105 to determine the pulsing frequency to keep the temperature rise around 3° C., and sends a corresponding speed command to the coolant pump 125. If the stack 105 load is below the lower threshold, then the speed command pulses between 0 revolutions per minute (rpm) and the minimum pump 125 speed (which may typically be around 1800 rpm). If the stack 105 load is between the upper and lower threshold, then the speed command pulses between 1000 rpm and the minimum speed of pump 125. The enable criteria is continually monitored and if any of the parameters fall out of range, then normal flow control is resumed, as shown in steps 310 and 306. Otherwise, flow pulsing continues.

Many modifications and variations of embodiments of the present invention are possible in light of the above description. The above-described embodiments of the various systems and methods may be used alone or in any combination thereof without departing from the scope of the invention. Although the description and figures may show a specific ordering of steps, it is to be understood that different orderings of the steps are also contemplated in the present disclosure. Likewise, one or more steps may be performed concurrently or partially concurrently.

What is claimed is:

1. A method for controlling a coolant pump in a fuel cell system, said method comprising:
determining whether a stack power request for a fuel cell stack is below a first threshold value;
utilizing said stack power request to determine an off time value for said coolant pump that provides coolant to said fuel stack; and
generating, by a processor, a coolant pump control command that causes said coolant pump to stop providing coolant to said fuel stack during said off time and to provide coolant to said fuel stack during an on time, said coolant pump control command continuing as long as said stack power request is below said first threshold value.

2. The method of claim 1, wherein said first threshold value is a current density equal to 0.1 Amperes per square centimeter.

3. The method of claim 2, wherein said on time is about 5 seconds.

4. The method of claim 1, wherein said on time comprises a minimum time that said coolant pump must run in order to remove the heat produced by the fuel cell stack during said coolant pump off time.

5. The method of claim 1, further comprising determining whether said stack power request for said fuel cell stack is below a second threshold value, wherein said coolant pump control command is generated if said stack power request is below said second threshold value and above said first threshold value.

6. The method of claim 5, wherein said second threshold value is a current density equal to about 0.2 Amperes per square centimeters.

7. The method of claim 1, wherein said first threshold value is a power value, a current value or a current density value.

8. The method of claim 1, wherein said coolant pump control command corresponds to a minimum pump pulsing frequency needed to limit a local temperature rise above an average system temperature.

9. The method of claim 8, wherein said local temperature rise above an average system temperature is no more than about 3° C.

10. A pump controller for a fuel cell system comprising:
at least one processor; and
a non-transitory memory in communication with said at least one processor, wherein said memory stores instructions that, when executed by said at least one processor, cause said at least one processor to:
determine whether a stack power request for a fuel cell stack is below a first threshold value;
utilize said stack power request to determine an off time value for a coolant pump that provides coolant to said fuel stack; and
generate a coolant pump control command that causes said coolant pump to stop providing coolant to said fuel stack during said off time and to provide coolant to said fuel stack during an on time, said coolant pump control command continuing as long as said stack power request is below said first threshold value.

11. The pump controller of claim 10, wherein said first threshold value is a current density equal to 0.1 Amperes per square centimeter.

12. The pump controller of claim 10, wherein said generated control command further comprises ensuring that said on time comprises a minimum time that said coolant pump must run in order to remove the heat produced by the fuel cell stack during said coolant pump off time.

13. The pump controller of claim 10, wherein said instructions further cause said at least one processor to determine whether said stack power request for said fuel cell stack is below a second threshold value, wherein said coolant pump control command is generated if said stack power request is below said second threshold value and above said first threshold value.

14. The pump controller of claim 13, wherein said second threshold value is a current density equal to about 0.2 Amperes per square centimeters.

15. The pump controller of claim 10, wherein said first threshold value is a power value, a current value or a current density value.

16. The pump controller of claim 10, wherein said coolant pump control command corresponds to a minimum pump pulsing frequency needed to limit a local temperature rise above an average system temperature.

17. The pump controller of claim 16, wherein said local temperature rise above an average system temperature is no more than about 3° C.

18. A fuel cell system comprising:
a fuel cell stack;
a pump that controls a supply of a coolant through said fuel cell stack; and
a pump controller including at least one processor and a non-transitory memory in communication with said at least one processor, wherein said memory stores instructions that, when executed by said at least one processor, cause said at least one processor to determine whether a stack power request for a fuel cell stack is below a first threshold value, to utilize said stack power request to determine an off time value for a coolant pump that provides coolant to said fuel stack, and to generate a coolant pump control command that causes said coolant pump to stop providing coolant to said fuel stack during said off time and to provide coolant to said fuel stack during an on time, said coolant pump control command continuing as long as said stack power request is below said first threshold value.

19. The fuel cell system of claim 18, wherein said on time comprises a minimum time that said coolant pump must run in order to remove the heat produced by the fuel cell stack during said coolant pump off time.

20. The fuel cell system of claim 18, wherein said coolant pump control command corresponds to a minimum pump pulsing frequency needed to limit a local temperature rise above an average system temperature.
